(19) United States
(12) Patent Application Publication
(10) Pub. No.: US 2026/0073904 A1
(43) Pub. Date: Mar. 12, 2026

(54) Zero-Shot Cross-Lingual Voice Transfer for Text-To-Speech

(71) Applicant: Google LLC, Mountain View, CA (US)

(72) Inventors: Fadi Biadsy, Sandyston, NJ (US); Joseph Chen, Mountain View, CA (US); Isaac Elias, Mountain View, CA (US); Kyle Scott Kastner, Waltham, MA (US); Gary Wang, Mountain View, CA (US); Andrew M. Rosenberg, Brooklyn, NY (US); Bhuvana Ramabhadran, Mt. Kisco, NY (US)

(73) Assignee: Google LLC, Mountain View, CA (US)

(21) Appl. No.: 19/326,475

(22) Filed: Sep. 11, 2025

Related U.S. Application Data
(60) Provisional application No. 63/694,164, filed on Sep. 12, 2024.

(51) Int. Cl. G10L 13/027; G10L 13/047

(52) U.S. Cl. CPC G10L 13/027; G10L 13/047

(57) ABSTRACT

A method for performing zero-shot voice transfer using text-to-speech (TTS) includes receiving an input text sequence characterizing an utterance and receiving a reference speech representation characterizing a reference utterance spoken by a target speaker. The method also includes generating an encoded textual representation for the input text sequence, processing, using a speaker encoder, the reference speech representation to generate a speaker representation characterizing voice characteristics of the target speaker and learning fine-grained embedding vectors based on the speaker representation to obtain a final embedding vector. The method also includes predicting a duration and upsampling the encoded textual representation into an upsampled output. The method also includes generating a synthesized speech representation based on the upsampled output and the final embedding vector and generating a time-domain audio waveform of the input text sequence that clones a voice of the target speaker.

### CROSS REFERENCE TO RELATED APPLICATIONS

This U.S. patent application claims priority under 35 U.S.C. § 119(e) to U.S. Provisional Application 63/694,164, filed on Sep. 12, 2024. The disclosure of this prior application is considered part of the disclosure of this application and is hereby incorporated by reference in its entirety.

### TECHNICAL FELD

This disclosure relates to zero-shot cross-lingual voice transfer for text-to-speech

### BACKGROUND

Text-to-speech (TTS) systems read aloud digital text to a user and are becoming increasingly popular on mobile devices. Certain TTS models aim to synthesize various aspects of speech, such as speaking styles, to produce human-like, natural sounding speech. Synthesis in TTS models is a one-to-many mapping problem, as there can be multiple possible speech outputs for the different prosodies of text inputs. Many TTS systems utilize an autoregressive model that predicts current values based on previous values. While autoregressive TTS models can synthesize text and generate highly natural speech outputs, the hundreds of calculations required reduce efficiency during inference.

Significant advances in Voice Transfer (VT) technology integrated into TTS systems have achieved great progress of speaker similarity on unseen speakers. However, these advances have required longer reference audio length of unseen speakers, high costs of audio quality, and full fine-tuning of the underlying models. Known approaches for cross-lingual VT require the language of the reference audio to match the language of the target audio.

### SUMMARY

One aspect of the disclosure provides a computer-implemented method that when executed on data processing hardware causes the data processing hardware to perform operations that include: receiving an input text sequence characterizing an utterance to be converted into synthesized speech; receiving a reference speech representation characterizing a reference utterance spoken by a target speaker; generating, using a text encoder, a text-to-speech (TTS) encoded textual representation for the input text sequence; processing, using a speaker encoder of a voice transfer (VT) module, the reference speech representation to generate a speaker representation characterizing voice characteristics of the target speaker; learning, using a bottleneck layer having an attention mechanism configured to attend to the speaker representation, fine-grained embedding vectors; and obtaining a final embedding vector based on the fine-grained embedding vectors. Using a duration model network, the operations also include predicting, based on the TTS encoded textual representation, a duration of the input text sequence, and upsampling, based on the duration of the input text sequence, the TTS encoded textual representation into an upsampled output specifying a number of frames. The operations also include generating, using a speech decoder configured to receive the upsampled output and the final embedding vector, a synthesized speech representation of the input text sequence, and processing, using a speech synthesizer, the synthesized speech representation to generate a time-domain audio waveform of the input text sequence that clones a voice of the target speaker.

Implementations of the disclosure may include one or more of the following optional features. In some implementations, the speaker representation includes a sequence of speaker vectors and obtaining the final embedding vector includes performing average pooling on the sequence fine-grained embedding vectors to generate an average-pooled speaker embedding vector. Here, the average-pooled speaker embedding vector includes the final embedding vector. In other implementation, the speaker representation includes a pooled summary speaker vector obtained by performing pooling and L2 normalization on a sequence of speaker embedding vectors output by the speaker encoder, and obtaining the final embedding vector includes computing a weighted average of the fine-grained embedding vectors. Here, the weighted average of the fine-grained embedding vectors includes the final embedding vector. In these implementations, the bottleneck layer may include multiple bottleneck layers replicated to each of the duration model network and each layer of the spectrogram decoder, wherein each bottleneck layer of the multiple bottleneck layers configured to receive the pooled summary speaker vector.

In some examples, the duration model network includes one or more multi-head attention layers and an output of each multi-head attention layer of the duration model network is concatenated with the final embedding vector via a residual adapter. In some additional examples, the speech decoder includes one or more multi-head attention layers and an output of at least one multi-head attention layer of the speech decoder is concatenated with the final embedding vector via a residual adapter.

The utterance characterized by the input text sequence may be different than the reference utterance. The reference utterance spoken by the target speaker may be in a different language than the utterance characterized by the input text sequence. The speaker encoder may include a convolutional layer followed by a stack of multi-head attention layers such as Transformer layers or Conformer layers.

Another aspect of the disclosure provides a system that includes data processing hardware and memory hardware storing instructions that when executed on the data processing hardware cause the data processing hardware to perform operations that include: receiving an input text sequence characterizing an utterance to be converted into synthesized speech; receiving a reference speech representation characterizing a reference utterance spoken by a target speaker; generating, using a text encoder, a text-to-speech (TTS) encoded textual representation for the input text sequence; processing, using a speaker encoder of a voice transfer (VT) module, the reference speech representation to generate a speaker representation characterizing voice characteristics of the target speaker; learning, using a bottleneck layer having an attention mechanism configured to attend to the speaker representation, fine-grained embedding vectors; and obtaining a final embedding vector based on the fine-grained embedding vectors. Using a duration model network, the operations also include predicting, based on the TTS encoded textual representation, a duration of the input text sequence, and upsampling, based on the duration of the input text sequence, the TTS encoded textual representation into an upsampled output specifying a number of frames. The operations also include generating, using a speech decoder configured to receive the upsampled output and the final embedding vector, a synthesized speech representation of the input text sequence, and processing, using a speech synthesizer, the synthesized speech representation to generate a time-domain audio waveform of the input text sequence that clones a voice of the target speaker.

Implementations of the disclosure may include one or more of the following optional features. In some implementations, the speaker representation includes a sequence of speaker vectors and obtaining the final embedding vector includes performing average pooling on the sequence fine-grained embedding vectors to generate an average-pooled speaker embedding vector. Here, the average-pooled speaker embedding vector includes the final embedding vector. In other implementation, the speaker representation includes a pooled summary speaker vector obtained by performing pooling and L2 normalization on a sequence of speaker embedding vectors output by the speaker encoder, and obtaining the final embedding vector includes computing a weighted average of the fine-grained embedding vectors. Here, the weighted average of the fine-grained embedding vectors includes the final embedding vector. In these implementations, the bottleneck layer may include multiple bottleneck layers replicated to each of the duration model network and each layer of the spectrogram decoder, wherein each bottleneck layer of the multiple bottleneck layers configured to receive the pooled summary speaker vector.

In some examples, the duration model network includes one or more multi-head attention layers and an output of each multi-head attention layer of the duration model network is concatenated with the final embedding vector via a residual adapter. In some additional examples, the speech decoder includes one or more multi-head attention layers and an output of at least one multi-head attention layer of the speech decoder is concatenated with the final embedding vector via a residual adapter.

The utterance characterized by the input text sequence may be different than the reference utterance. The reference utterance spoken by the target speaker may be in a different language than the utterance characterized by the input text sequence. The speaker encoder may include a convolutional layer followed by a stack of multi-head attention layers such as Transformer layers or Conformer layers.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is an example system for training a deep neural network to provide a massively multilingual text-to-speech (TTS) model integrating a Voice Transfer (VT) module that performs zero-shot voice conversion across languages.

FIG. 2 is a schematic view of the multilingual TTS model integrating the VT module non-autoregressive TTS model.

FIGS. 3A-3E are schematic views of an example training process for training a text-to-speech (TTS) model using sets of training utterances.

FIG. 4 is a schematic view of an example alignment model used during the example training process.

FIG. 5 is a schematic view of an example training process for the alignment model.

FIG. 6 is a schematic view an example bottleneck layer of the VT module of FIGS. 1 and 2.

FIG. 7 is a flowchart of an exemplary arrangement of operations performing zero-shot voice conversion across languages.

FIG. 8 is a schematic view of an example computing device that may be used to implement the systems and methods described herein.

Like reference symbols in the various drawings indicate like elements.

### DETAILED DESCRIPTION

The synthesis of realistic human speech is an underdetermined problem in that a same text input has an infinite number of reasonable spoken realizations. While end-to-end neural network-based approaches are advancing to match human performance for short assistant-like utterances, neural network models are sometimes viewed as less interpretable or controllable than more conventional models that include multiple processing steps each operating on refined linguistic or phonetic representations. Sources of variability in speech include prosodic characteristics of intonation, stress, rhythm, and style, as well as speaker and channel characteristics. The prosodic characteristics of a spoken utterance convey linguistic, semantic, and emotional meaning beyond what is present in a lexical representation (e.g., a transcript of the spoken utterance).

Neural networks are machine learning models that employ one or more layers of nonlinear units to predict an output for a received input. For instance, neural network-based end-to-end text-to-speech (TTS) models may convert input text to output speech. Neural network TTS models provide potential for robustly synthesizing speech by predicting linguistic factors corresponding to prosody that are not provided by text inputs. As a result, a number of applications, such as audiobook narration, news readers, voice design software, and conversational assistants can produce realistically sounding synthesized speech that is not monotonous-sounding.

Many neural end-to-end TTS models utilize an autoregressive model that predicts current values based on previous values. For instance, many autoregressive models are based on recurrent neural networks that use some or all of an internal state of the network from a previous time step in computing an output at a current time step. An example of a recurrent neural network is a long short term (LSTM) neural network that includes one or more LSTM memory blocks. Each LSTM memory block can include one or more cells that each include an input gate, a forget gate, and an output gate that allows the cell to store previous states for the cell, e.g., for use in generating a current activation or to be provided to other components of the LSTM neural network.

While autoregressive T S models can synthesize text and generate highly natural speech outputs, their architecture through a series of uni-directional LSTM-based decoder blocks with soft attention inherently makes both training and inference less efficient when implemented on modern parallel hardware compared to fully-feedforward architectures. Moreover, as autoregressive models train via teacher forcing by applying ground truth labels for each time step, autoregressive models are additionally prone to producing discrepancies between training and when the trained model is applied during inference. Together with the soft attention mechanism, these discrepancies can lead to synthesized speech output with reduced quality, such as the synthesized speech exhibiting robustness errors such as babbling, early cut-off, word repetition, and word skipping. The reduction in quality of synthesized speech in autoregressive TTS models may be further exacerbated as a size of the synthesized text increases.

To alleviate the aforementioned drawbacks of autoregressive-based TTS models, implementations herein are directed toward a non-autoregressive neural TTS model. The non-autoregressive neural TTS model includes a text-to-feature (T2F) component and a feature-to-speech (F2S) component that includes a synthesizer (e.g., neural vocoder). The T2F component includes a text encoder, a duration model network, and a feature (e.g., spectrogran) decoder.

In some instances, TTS models are multilingual whereby the TTS model may receive a text input and generate synthetic speech corresponding to the text input in multiple different languages. Recently, TTS models have made significant advances in synthesizing hurman-like high-quality speech in multiple languages. Implementations herein are further directed toward training a massively multilingual TTS model to perform zero-shot voice conversion across languages by integrating a zero-shot voice transfer (VT) module with a joint speech-text model that includes the T2F component, the F2S component, a feature-to-text (F2T) component, and a speech-to-feature (S2F) component. Notably, the S2F and F2T components of the joint speech-text model may form a recurrent neural network-transducer (RNN-T) automated speech recognition (ASR) model, while the T2F and F2S components form the non-autoregressive neural TTS model for use during inference. The S2F component includes a pre-trained speech encoder that includes a plurality of multi-head attention layers. In some examples, the speech encoder includes six Conformer layers. The pre-trained speech decoder may be pretrained using a self-supervised learning (SSL) objective, such as BERT-based Speech pre-Training with Random projection Quantizer (BIEST-RQ) and fine-tuned with the Multi-Objective Supervised pre-Training (MOST) objective. The F2T component includes a shared encoder including a plurality of multi-head attention layers and an auxiliary decoder. In some examples, the shared encoder includes 18 Conformer layers and the auxiliary decoder includes an RNN-T decoder configured to predict UTF-9 byte tokens. ASR training is performed on the S2F and F2T components to provide alignments for the T2F component. Namely, a path along the S2F and F2T components is configured to generate pseudo-labels for unsupervised training. Here, the pre-trained speech encoder of the S2F component may be frozen while the ASR training is performed. A path along the T2F and F2T components is used for unsupervised text training. The F2S component is used during supervised training. In some examples the F2S component includes a pretrained WaveFit vocoder that is kept frozen during the supervised training. Accordingly, the joint speech-text model is initially trained within a joint speech-text training framework where both the T2F and F2T components are jointly optimized on ASR and TTS data, while the pretrained speech encoder of the S2F component and the pretrained synthesizer (e.g., WaveFit vocoder) of the F2S component are kept frozen. As a result, the joint speech-text training framework optimizes the non-autoregressive neural TTS model formed by the T2F and F2S components to accept both text and reference speech. An example of the joint speech-text model is disclosed in Takaaki Saeki et al, “Extending Multilingual Speech Synthesis To 100+ Languages Without Transcribed Data,” arxiv:2402.18932v2, 2024, the contents of which are incorporated by reference in its entirety.

After the T2F and F2T components are optimized on the ASR and TTS data via the joint speech-text training framework, implementations are directed toward integrating the zero-shot VT module into the form the non-autoregressive multilingual TTS model formed by the T2F and F2S components by jointly training the zero-shot VT module and the T2F and F2S components on a multilingual training data that includes a multilingual ASR training data set and a multilingual TTS training dataset. The multilingual ASR training dataset may include a plurality of multilingual training audio samples each characterizing a corresponding long-form utterance paired with a corresponding transcription of the corresponding long-form utterance. The multilingual TTS training data may include a plurality of recorded utterances spoken by multiple voice actors across several locals. The multilingual ASR and TTS training datasets may collectively include multilingual utterances spanning over 100 different locals.

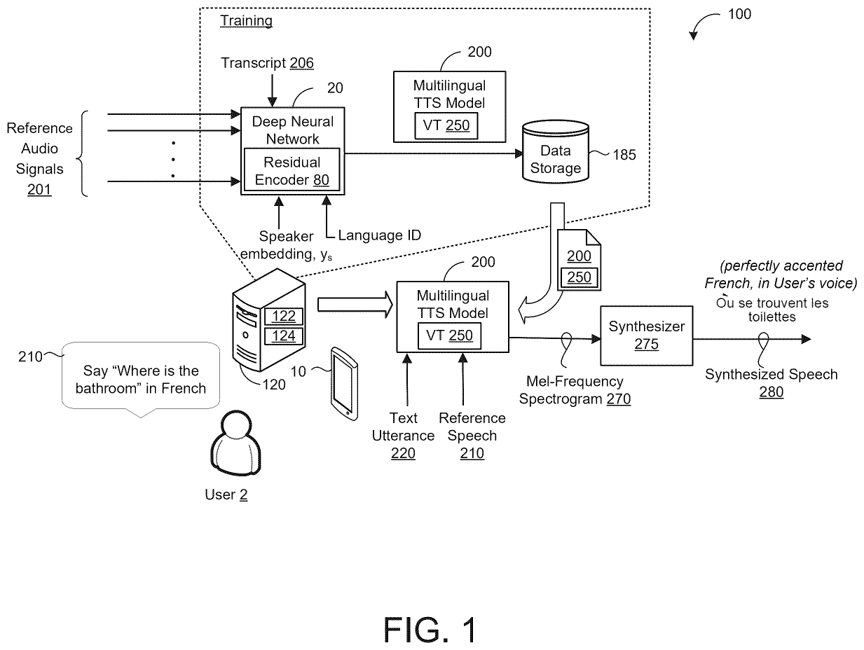

FIG. 1 shows an example system 100 for training a deep neural network 20 to provide a massively multilingual TTS model 200 integrating a Voice Transfer (VT) module 240 that performs zero-shot voice conversion across languages. Notably, the multilingual TTS model 200 integrating the VT module 240 is capable of transferring a voice from reference speech into synthesized speech in a target language even when the reference speech is in a different language than the target language. Once trained, the multilingual TTS model integrating the VT module 240 can receive reference speech 210 and a text utterance 220 and predict a spectrogram 202 for the text utterance 220 in the same voice as the reference speech 210. The system 100 includes a computing system 120 having data processing hardware 122 and memory hardware 124 in communication with the data processing hardware 122 and storing instructions that cause the data processing hardware 122 to perform operations. In some implementations, the computing system 120 (e.g., the data processing hardware 122) or a user computing device 10 executes the trained TTS model 200 integrating the VT module 240 to provides the predicted mel-frequency spectrogram 270 from the input text utterance 220 and having the same voice characteristics as the reference speech 210 to a synthesizer 275 for conversion into a time-domain audio waveform indicative of synthesized speech 280 that may be audibly output as a spoken representation of the input text utterance 220. A time-domain audio waveform includes an audio waveform that defines an amplitude of an audio signal over time. The synthesizer 275 may be separately trained and conditioned on mel-frequency spectrograms for conversion into time-domain audio waveforms.

A mel-frequency spectrogram includes a frequency-domain representation of sound. Mel-frequency spectrograms emphasize lower frequencies, which are critical to speech intelligibility, while de-emphasizing high frequency, which are dominated by fricatives and other noise bursts and generally do not need to be modeled with high fidelity. The synthesizer 275 may include a vocoder neural network that may include any network that is configured to receive mel-frequency spectrograms and generate audio output samples (e.g., time-domain audio waveforms) based on the mel-frequency spectrograms. For example, the vocoder network 275 may include a waveform synthesizer such as a pre-trained WaveFit vocoder. Notably, the vocoder 275 may be pretrained on only English-language utterance. The choice of the synthesizer 275 has no impact on resulting prosody/style of the synthesized speech 280, and in practice, only impacts audio fidelity of the synthesized speech 280

In the example of FIG. 1, the multilingual TTS model 200 integrating the VT module 240 is implemented on, or accessible by, the user device 10 of an English-speaking user 2. The user device 10 may execute an audio subsystem configured to receive the reference speech 210 from the user 2 and output, from the TTS model 200 integrating the VT module 240 synthesized speech 280 in the voice of the user 2. While the user device 10 includes a mobile device in the example, other examples of the user device 10 include any type of computing device such as a smart phone, a tablet, an Internet-of-Things (IoT) device, a wearable device, a digital assistant device, or a desktop or laptop computer.

FIG. 1 also illustrates an example interaction between the user 2 and the user device 110. Here, the device 120 captures the reference speech 210 from the user 2 that states, in a first natural language of English, “‘Where is the bathroom?’ in French.” The reference speech is processed by the TTS model 200 integrating the VT module 240 to output, in perfectly accented French and cloning (e.g., voice transfer) the user's 10 voice, synthesized speech 280 which states, “Où se trouvent les toilettes?” With the VT module 240 integrated into the multilingual TTS model 200, the voice of the user 2 can be extracted from the English reference speech 210 and transferred into the synthesized speech 280 in French despite the fact that the user 2 does not speak French, and despite the multilingual TTS model 200 and the VT module 240 not being trained with any samples of the user 2 speaking any utterances, much less utterances spoken by the user 2 in French. In this example, a speech recognizer may convert the reference speech 210 into the text utterance 220 which may then be translated into French before input to the model 200. In other examples, the user 2 inputs the textual utterance 220 into the user device 10 and separately speaks the reference speech 210 to provide the voice characteristics of the user 2. That is, the user may provide the text utterance 220 conveying the linguistic content the user 2 wants to be converted into synthesized speech and speak a phrase such as “Say it in my voice” as reference speech 210 so that the resulting synthesized speech 280 is in the voice of the user 2. Notably, the user 10 may input a language identifier specifying a target language for the synthesized speech. In some examples, the user 10 specifies the target language in the reference speech, e.g., “Speak it in French”.

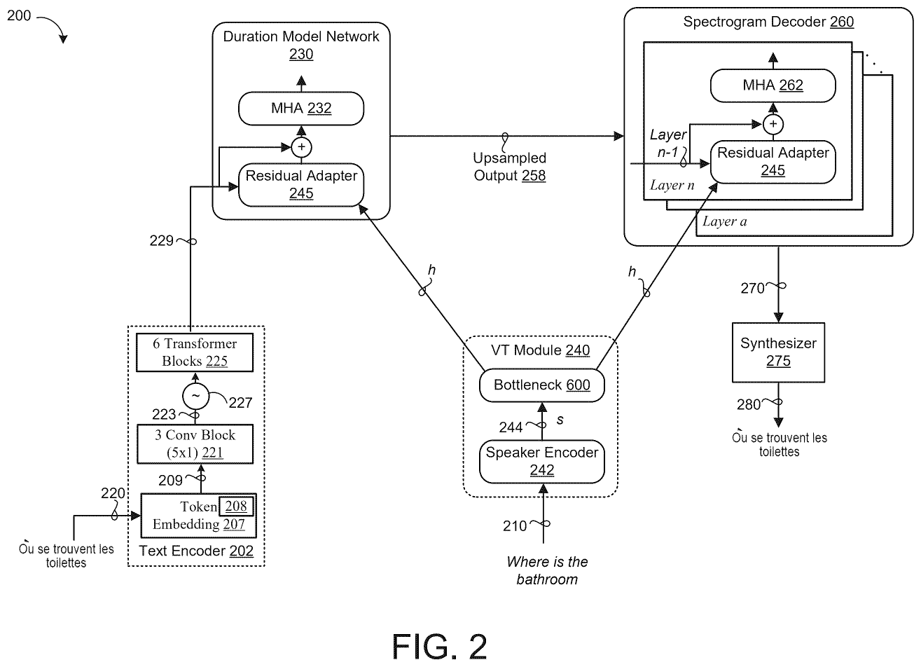

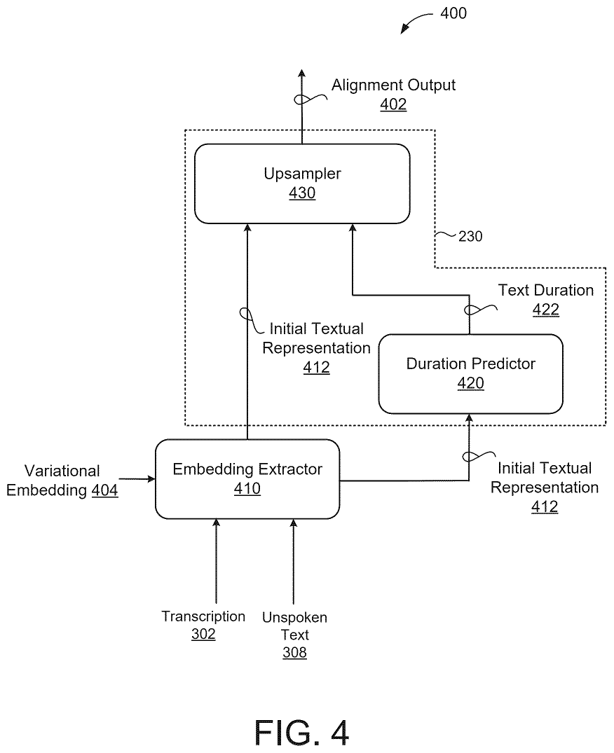

FIG. 2 shows the multilingual TTS model 200 integrating the VT module 240 to perform zero-shot voice transfer across languages. The multilingual TTS model 200 includes a non-autoregressive architecture implemented by a text encoder 210, a duration model network 230, and a speech decoder 260 that predicts speech features 270 such as a sequence of mel-frequency spectrograms 302 characterizing a synthetic speech representation of a text utterance 220. The speech decoder 260 may be referred to as a feature decoder or a spectrogram decoder configured to predict the sequence of mel-frequency spectrograms 270. The duration model network 230 may include a duration predictor 420 (FIG. 4) and an upsampler 430 (FIG. 4). A synthesizer 275 converts the sequence of mel-frequency spectrograms 270 into a time-domain audio waveform indicative of synthesized speech 280 that may be audibly output from an audio output device (e.g., speaker). In some examples, the synthesizer 275 includes a pre-trained WaveFit vocoder that is not updated during training and that was previously trained on uni-language (e.g, English) speech. The multilingual TTS model 200 includes a non-autoregressive architecture, whereby the text encoder 210, the duration model network 230, and the speech decoder 260 correspond to a text-to-feature (T2F) component and the synthesizer 275 corresponds to a feature-to-speech (S2F) component. Details of the text encoder 210, the duration model network 230, and the speech decoder 260 are described in the non-autoregressive neural TTS model disclosed in U.S. application Ser. No. 17/326,542, filed on May 21, 2021, the contents of which are incorporated by reference in its entirety. However, as described in greater detail below, the duration model network 230 and the speech decoder 260 are modified to further implement residual adapters 245 associated with the zero-shot VT module 240.

The text encoder 202 encodes a sequence of phonemes extracted from the text utterance 220 into a TTS encoded text sequence 229. The input text utterance 220 may be referred to as an input text sequence 220. The text encoder 202 may receive, from an token embedding look-up table 207, a respective token embedding for each phoneme in the sequence of phonemes extracted from the text utterance 220. After receiving the respective token embedding of each phoneme in the sequence of phonemes extracted from the text utterance 220, the text encoder 202 uses an encoder pre-net neural network 208 to process each respective token embedding to generate a respective transformed embedding 209 of each phoneme. Thereafter, a bank of Conv blocks 221 (e.g., three (3) identical 5×1 Conv blocks) processes the respective transformed embeddings 209 to generate convolution outputs 223. Finally, a stack of self-attention blocks 225 process the convolution outputs 223 to generate the encoded text sequence 229. In the example shown, the stack of self-attention blocks 218 includes six (6) Transformer blocks. In other examples, the self-attention blocks 225 may include Conformer blocks or LConv blocks in lieu of Transformer blocks. Notably, since each convolution output 223 flows through the stack of self-attention blocks 225 simultaneously, the stack of self-attention blocks 225 have no knowledge of position/order of each phoneme in the input text utterance. Thus, in some examples, sinusoidal positional embeddings 227 are combined with the convolution output 223 to inject necessary position information indicating the order of each phoneme in the input text sequence 220. In other examples, encoded positional embeddings are used in place of the sinusoidal positional embeddings 227.

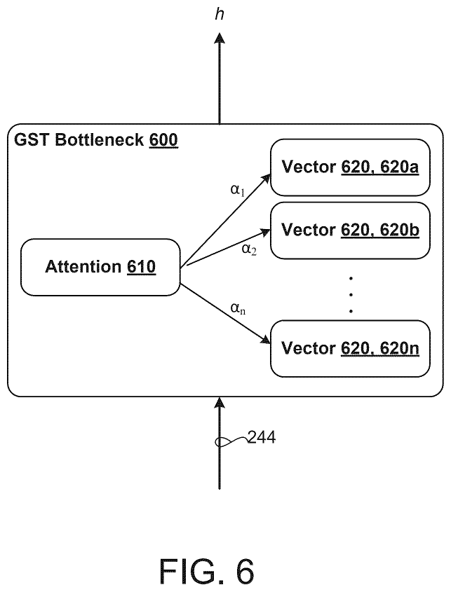

By integrating the VT module 240 into the multilingual TTS model 200, the zero-shot VT module 240 can receive reference speech 210 to enable the TTS model 200 to transfer voice characteristics in the reference speech 210 to generate the synthesized speech with the same voice characteristics. The VT module 240 includes a speaker encoder 242, one or more bottleneck layers 600, and the residual adapters 245. The speaker encoder 242 processes a 1-15 second segment of the reference speech 210 (i.e., interchangeably referred to as ‘reference speech representation’) to generate a speaker representation (s) 244 that characterizes the voice characteristics of the user. The speaker encoder 242 may include five convolution layers with 3×1 filters followed by a stack of multi-head attention layers to produce 1024-dimnensional speaker embedding vectors. The stack of multi-head attention layers may include a stack of eight Transformer layers. Optionally, pooling and L2 normalization may be performed on the speaker embedding vectors to produce a pooled summary speaker vector as the speaker representation. The bottleneck layer 600 has an attention mechanism 610 (FIG. 6) that attends to the speaker representation 244 such that the bottleneck layer 600 learns fine-grained embedding vectors 620. A final embedding vector (h) may be obtained based on the fine-grained embedding vectors 620. Depending on the type of bottleneck layer 600, the bottleneck layer 600 may receive either the sequence of speaker embedding vectors as the speaker representation (s) 244 or the pooled summary speaker vector as the speaker representation 244. The final embedding vector (h) output from the bottleneck layer 600 summarizes the acoustic-phonetic and prosodic characteristics of the reference speech 210. The residual adapters 245 integrated into the duration model network 230 and at least one layer of the speech decoder 260 each receive a concatenation of the final embedding vector (h) output from the bottleneck layer 600 and the previous layer's output. Here, the duration model network 230 predicts, based on the TTS encoded textual representation 229, a duration of the input text utterance 220 and upsamples, based on the duration of the input text utterance 220, the TTS encoded textual representation 229 into an upsampled output 258 specifying a number of frames. The speech decoder 260 is configured to receive the upsampled output 258 and the final embedding vector (h) and generate the synthesized speech representation 270 of the text utterance 220. The synthesized speech representation 270 may include a mel-frequency spectrogram. The speech synthesizer 275 may process the synthesized speech representation to generate a time-domain audio waveform of the input text utterance that clones the voice of the user that spoke the reference speech 210. Notably, the duration model network 230 may predict a phoneme duration for each phoneme represented by the TTS encoded textual representation 229 and then upsample a sequence representation into the upsampled output 258 with the number of frames. Here, the number of frames of the upsampled output 258 corresponds to a predicted length of the predicted mel-frequency spectrogram 270 based on the predicted phoneme duration of the corresponding input text utterance 220.

FIG. 6 shows an example bottleneck layer 600 that includes a shared Global Style Token (GST) layer that uses the attention mechanism 610 and a 1024 learned bank of fine-grained embedding vectors 620, 620a-n. The attention mechanism 610 receives the pooled summary speaker vector as the speaker representation 244 from the speaker encoder 242 and uses 4-headed dot-product attention to compute its similarity to each of the fine-grained vectors 620 in the GST bank. Corresponding attention weights a are then used to compute a weighted average of the fine-grained embedding vectors 620 to produce the final embedding vector (h). Accordingly, the bottleneck 600 constrains the vectors 620a-n to lie within the learned simplex such that one can view the vertices of the simplex as bases of voices, and a new voice is a convex combination of those voice bases.

In some examples, the bottleneck layer 600 is replicated to each of the duration model network 230 and the multiple layers of the speech decoder 260. For instance, one bottleneck layer 600 may be integrated in the duration model network 230 and six bottleneck layers 600 may integrated into the six layers of the speech decoder 260. Each of the replicated bottleneck layers 600 may consume the same pooled summary speaker vector as the speaker representation 244. In these examples, different embedding information may be extracted from the same speaker such that each of the layers are benefited differently.

In yet another example, the attention mechanism 610 of the bottleneck layer 600 attends to the entire sequence of speaker embedding vectors as the speaker representation (s) 244 instead of attending to a pooled summary vector. Here, the length of the sequence of speaker embedding vectors may be reduced by a factor of 16, and using 2× convolution layers (each with 4-strided 8×1 filters) placed after the speaker encoder 242 to locally extract information from wider context to generate the sequence of fine-grained embedding vectors 620. Finally, average pooling is performed on the sequence of fine-grained embedding vectors 620 to generate an average-pooled speaker embedding vector as the final embedding vector (h).

In some implementations, the bottleneck layer 600 instead includes a variational autoencoder (VAE) that uses a Gaussian posterior probability distribution and a unit Gaussian prior. The VAE may consume the summary speaker vector to produce a variational embedding as the final embedding vector (h).

The zero-shot VT module 240 is configured to extract/predict the final embedding vector (h) on the fly for use in predicting a mel-frequency spectrogram sequence 270 for the input text utterance 220 without requiring any additional training of the multilingual TTS model 200. For instance, the zero-shot VT module 240 may receive reference speech 220 uttered by a human user that conveys the voice (e.g., “Say it in my voice”) and extract/predict a corresponding final embedding vector (h) that represents the voice characteristics as well as prosodic/style characteristics. Thereafter, the trained TTS model 200 may use the final embedding vector to effectively transfer the voice characteristics conveyed by the reference speech to the mel-frequency spectrogram sequence 270 predicted for the input text utterance 220. Notably, the reference speech 210 may incl de a different utterance than the text utterance 220. Accordingly, the input text utterance 320 to be synthesized into speech 280 and the reference speech 210 conveying the voice characteristics to be transferred to the synthesized speech 280 may include different linguistic content. In some examples, the reference speech 210 and the synthesized speech 280 include different languages. In some additional examples, the reference speech 210 is spoken by an atypical speaker and the synthesized speech is perfectly fluent canonical speech in the atypical speaker's voice.

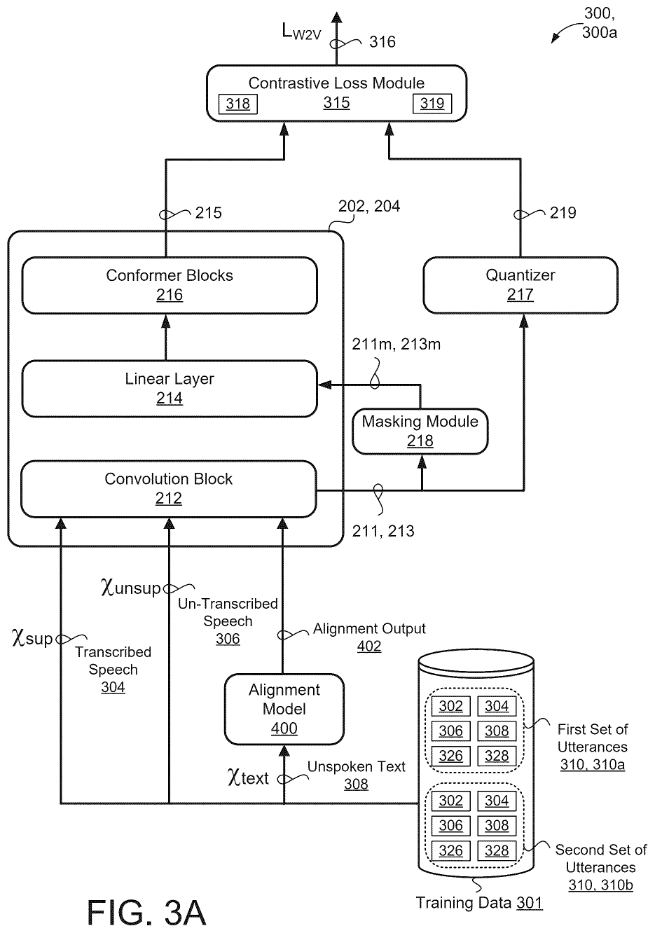

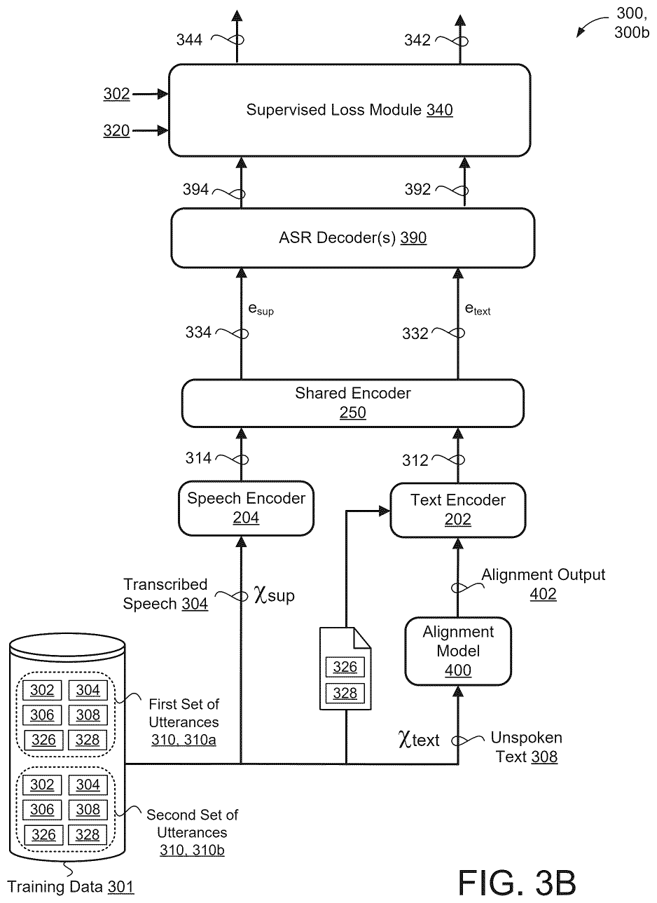

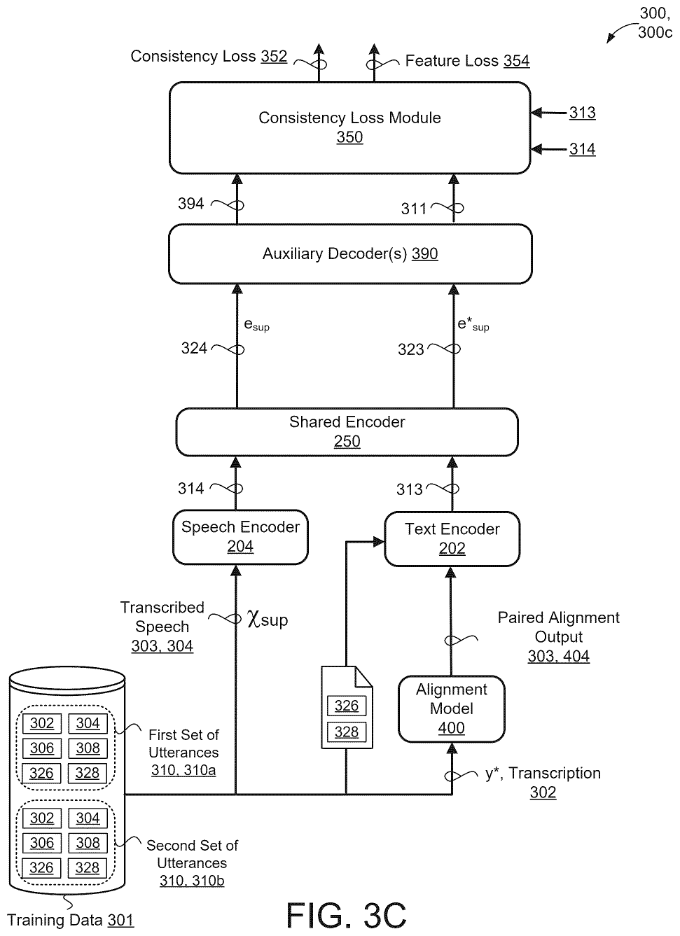

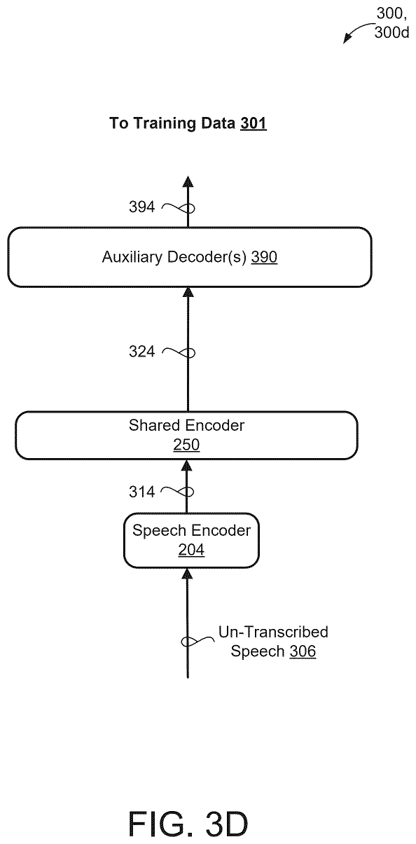

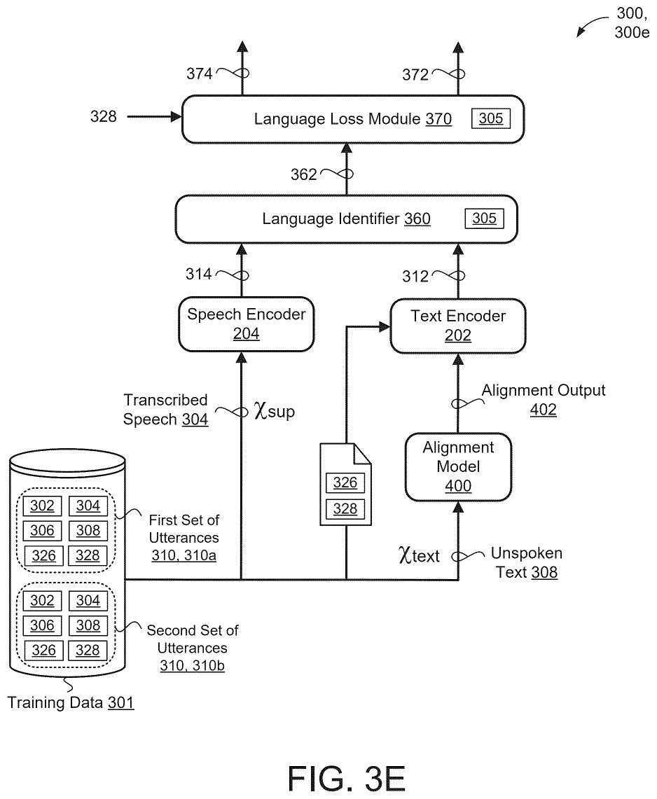

FIGS. 3A-3E illustrate an example training process 300 for training the TTS model 200 using sets of training utterances 310. In particular, the training process 300 may train the text encoder 202 of the TTS model 200. As will become apparent, the training process 300 may train the ITS model 200 using training data 301 that includes a plurality of sets of training utterances 310. More specifically, each set of training utterances 310 of the plurality of sets of training utterances 310 includes a set of unspoken textual utterances (Xₜₑₓₜ) 308, a set of transcribed speech utterances (Xₛᵤₚ) 304, and/or un-transcribed speech utterances (Xᵤₙₛᵤₚ) 306. The set of transcribed speech utterance 304 and the set of un-transcribed speech utterances 306 may each include non-synthetic speech utterances spoken by a human and/or synthetic speech utterances generated by another TTS model. Each unspoken textual utterance 308 includes text-only data (i.e., unpaired data) such that each unspoken textual utterance 308 is not paired with any corresponding spoken audio representation (i.e., speech) of the utterance. The unspoken textual utterance 308 may include any sequence text chunks including words, word-pieces (i.e., word-piece-model units), phonemes, bytes, and/or graphemes. Since the unspoken textual utterances 308 are unspoken, each unspoken textual utterance 308 may be associated with a respective plurality of different languages. As will become apparent, an alignment model 400 may generate an alignment output 402 for the unspoken textual utterance 308 in one or more different languages. Each un-transcribed speech utterance (i.e., unpaired spoken utterance) 306 includes audio-only data (i.e., unpaired data) such that the un-transcribed speech utterance 306 is not paired with any corresponding transcription. On the other hand, each transcribed speech utterance 304 includes a corresponding transcription (i.e., input text sequence) 302 paired with a corresponding speech representation of the corresponding transcribed speech utterance 304,

Moreover, each set of training utterances 310 is associated with a respective language that is different than the respective language associated with each other set of the training utterances 310 and includes training utterances 310 of speech spoken in the respective language. For instance, in the example shown, the training data 301 includes a first set of training utterances 310, 310a including transcriptions 302, transcribed speech utterances 304, un-transcribed speech utterances 306, and unspoken textual utterances 308 each associated with a first respective language (e.g., English). Continuing with the example shown, the training data 301 also includes a second set of training utterances 310, 310b including transcriptions 302, transcribed speech utterances 304, un-transcribed speech utterances 306, and unspoken textual utterances 308 each associated with a second respective language (e.g. Chinese). The example shown includes two sets of training utterances 310 associated with two respective languages for the sake of clarity only, as it is understood that the training data 301 may include a number of sets of training utterances 310 associated with any number of languages.

For simplicity, the training process 300 includes a contrastive self-supervised loss part 300a (FIG. 3A), a supervised loss part 300b (FIG. 313), and a consistency regularization part 300c (FIG. 3C). The training process 300 trains the TTS model 200 on a total loss (i.e., TTS loss 305) based on: contrastive losses (L_{w2v}) 316 derived using the contrastive self-supervised loss part 300a from the unspoken training text utterances (Xₜₑₓₜ) 308, a corpus of transcribed speech utterances (Xₛᵤₚ) 304, and urn-transcribed speech utterances (Xᵤₙₛᵤₚ) 306; supervised losses (Lₐᵤₓ) 342, 344 derived using the supervised loss part 300b from the unspoken training text utterances (Xₜₑₓₜ) 306 and the transcribed speech utterances (Xₛᵤₚ) 304; consistency losses [symbol] (θ)) 352 derived using the consistency regularization part 300c, and other losses determined by the training process discussed herein.

In some examples, the training process 300 employs an alignment model 400 that is configured to generate, at each of a plurality of output steps, alignment outputs (i.e., textual representation) 402 for a respective one of the plurality of unspoken training text utterances 308 and/or the transcriptions 302. Accordingly, the alignment model 400 may generate a corresponding alignment output 402 for each one of the unspoken textual utterances 308 and/or the transcriptions 302. Thereafter, the training process 300 trains the TTS model 200 using the generated alignment outputs 402.

Referring now to FIG. 4, in some examples, the alignment model 400 includes an embedding extractor 410, duration predictor 420, and an upsampler 430. The duration model network 230 of the ITS model 200 of FIG. 1 may implement the duration predictor 420 and the upsampler 430 of the alignment model 400. The embedding extractor 410 receives a respective one of the unspoken textual utterances 308 and/or the transcriptions 302. Here, the unspoken textual utterances 308 and the transcriptions 302 may each include a sequence of text chunks including words, word-pieces, phonemes, bytes, and/or graphemes. As such, the embedding extractor 410 extracts a corresponding initial textual representation (et) 412 for the respective one of the unspoken textual utterances 308 and/or transcriptions 302. For example, the embedding extractor 410 may receive a respective transcription 302 and extract the initial textual representation (i.e., sequence representation) 412 from the respective transcription 302. The initial textual representation 412 includes embedding lexical information from the sequence of text chunks. In some examples, the embedding extractor 410 concatenates the initial textual representation 412 with a variational embedding 404 and provides the concatenation to the duration predictor (i.e., duration model) 420. The duration predictor 420 receives the initial textual representation 412 (or the concatenation) from the embedding extractor 410 and predicts a corresponding text chunk duration (i.e., word, word-piece, phoneme, and/or grapheme duration) 422. The text chunk duration 422 indicates a duration the corresponding text chunk would be spoken if a human (or text-to-speech system) spoke the respective transcription 302. For example, the transcription 302 may include a sequence of phonemes and the duration predictor 420 predicts a phoneme duration 422 for each phoneme in the sequence of phonemes. In this example, the duration predictor 420 predicts the phoneme duration 422 by predicting a probability of non-zero duration for each phoneme and predicting a probability of continuous phoneme duration for each phoneme. As the sequence of phonemes includes regular phonemes, silences between word boundaries, and punctuation marks, only the regular phonemes are associated with non-zero duration while the silences and punctuation marks are generally associated with the continuous phoneme duration. Accordingly, the duration predictor 420 may use a sigmoid activation following a first one of two independent activations to predict the probability of non-zero duration and use a soft plus activation following a second one of the two independent projections to predict the continuous text chunk duration 422 for each text chunk. The duration predictor 420 determines, for each text chunk, whether the probability of non-zero duration is less than a threshold value, and when the probability of non-zero duration is less than the threshold value, a multiplier may zero-out the continuous text chunk duration 422 predicted by the softplus activation for the corresponding text chunk. Otherwise, when the probability of non-zero duration is not less than the threshold value, the predicted text chunk duration 422 may be set equal to the continuous phoneme duration predicted by the softplus activation.

The upsampler 430 receives each corresponding initial textual representation 412 output by the embedding extractor 410 and the corresponding predicted text chunk duration 422, and generates an alignment output (êₜ) 402 that has a number of frames by upsampling the initial textual representation 412 using the corresponding predicted text chunk duration 422. In some examples, the alignment model 400 sends the alignment output 402 to the text encoder 202. In other examples (not shown), the alignment model 400 sends the alignment output 402 to a shared encoder 250 (e.g., bypassing the text encoder 202). In these other examples, the alignment output 402 serves as the encoded textual representation 312 such that the shared encoder 250 may receive the alignment output 402 directly from the alignment model. In some additional examples, paired training data is available and the upsampler 430 generates the alignment output 402 as follows.

$${\hat{e}}_{t} = {θ}_{Refiner} ( Resample ( {e}_{t} , {Align}_{RNN - T} ( {e}_{S} , t ) ) ) \qquad ( 1 )$$

Here, the upsampler includes resampler and refiner layers that align the initial textual embedding 412 to align with a corresponding encoded audio representation 314 directly. In other examples, paired training data is not available and the upsampler 430 generates the alignment output 402 as follows.

$${\hat{e}}_{t} = {θ}_{Refiner} ( Resample ( {e}_{t} , {θ}_{duration} ( {e}_{t} ) ) ) \qquad ( 2 )$$

In particular, the number of frames of the alignment output 402 indicates a predicted speech duration of the respective one of the unspoken textual utterances 308 or transcriptions 302. Stated differently, the number of frames of the alignment output 402 maps (i.e., aligns) the sequence of text chunks of the text input to speech frames. Here, the upsamnpler 430 includes resampler and refiner layers that replicate the initial textual embedding 412 to match the predicted text chunk duration 422 (i.e., speech duration). As such, the alignment output 402 includes a textual representation of the text input (e.g., the unspoken textual utterances 308 and/or transcriptions 302) having a timing component that aligns with how a human would speak the text input.

Notably, in most instances, a TTS system) generates an audible output to give text input the timing component of human speech such that a training process may use the audible output (i.e., synthetic speech) to train the encoder 210. Thus, since the alignment model 400 generates the alignment output 402 that maps the sequence of text chunks to speech frames directly, the training process 300 does not require speech synthesis of speech to generate the alignment outputs 402. That is, the alignment model 400 does not convert the input text into synthetic speech.

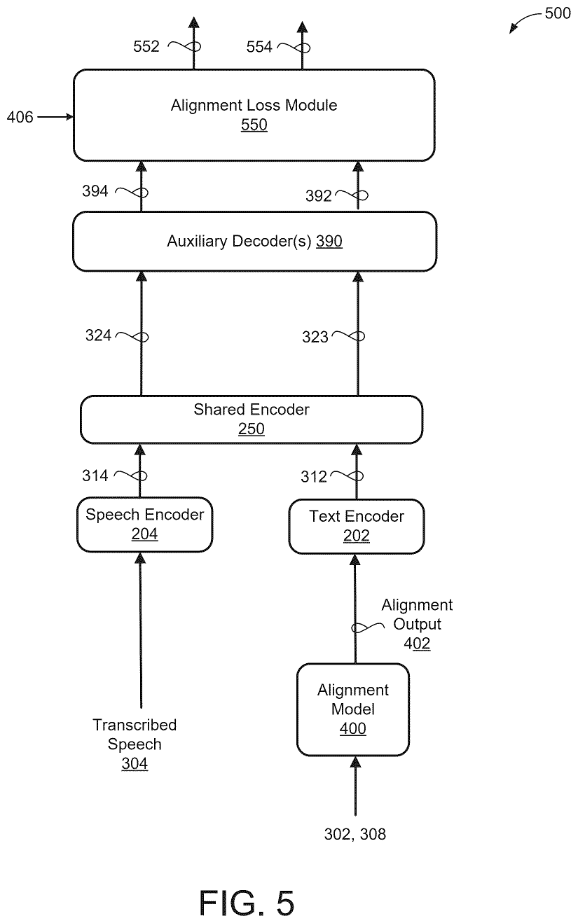

FIG. 5 illustrates an example training process 500 for training the alignment model 400 using paired training data and unpaired training data. That is, the training process 500 uses transcribed speech utterances 304 that have corresponding transcriptions 302 (i.e., paired training data) and unspoken textual utterances 308 (i.e., unpaired training data) to learn how to generate alignment outputs 402. In the example shown, the speech encoder 204 receives, as input, each transcribed speech utterance 304 as a sequence of features vectors (e.g., the acoustic frames 110 of FIG. 1) and generates, as output, for each of a plurality of output steps, an encoded audio representation (i.e., speech encoding) 314 that corresponds to the transcribed speech utterance 304 at the corresponding output step. When the speech encoder 204 generates the encoded audio representation 314 from un-transcribed speech 306, the encoded audio representation 314 represents an unpaired speech encoding 314. In parallel, the alignment model 400 receives the transcription 302 corresponding to the same transcribed speech utterance 304 and generates an alignment output 402 corresponding to the same transcribed speech utterance. Additionally or alternatively, the alignment model 400 may receive the unspoken textual utterance 308 and generate a corresponding alignment output 402. The text encoder 202 receives, as input, the alignment outputs 402 and generates, as output, for each of a plurality of output steps, an encoded textual representation 312. When the text encoder 202 generates the encoded textual representation 312 from an unspoken textual utterance 308, the encoded textual representation 312 represents an unspoken encoded textual representation 312.

A shared encoder 250 may receive, as input, the encoded textual representations 312, and generates, as output, a first encoded shared representation 322. The shared encoder 250 may also receive, as input, the encoded audio representations 314 and generate, as output, a second encoded shared representation 324. An auxiliary decoder 390 receives, as input, the first and second encoded shared representations 322, 324 and generates, as output, corresponding first and second probability distributions 392, 294 over possible speech recognition hypotheses.

An alignment loss module 550 receives the first probability distribution 392 corresponding to the encoded textual representation 312 and the second probability distribution 394 corresponding to the encoded audio representation 314 and generates an alignment loss 552 by comparing the first probability distribution 392 to the second probability distribution 394. In some implementations, the alignment loss module 550 determines a duration loss 554. Here, the alignment loss module 550 may receive the alignment output 402 specifying the number of frames (FIG. 4) and a corresponding ground-truth duration 406 paired with the corresponding transcription 302 or unspoken textual utterance 308 from which the alignment output 402 was generated. That is, the ground-truth duration 406 may represent the number of frames the upsampled output or alignment output 402 should have such that the alignment loss module 550 determines the duration loss 554 by comparing the predicted duration 422 of the input text sequence 412 (FIG. 4) and the ground-truth duration 406. The training process 500 may train any combination of components of the alignment model 400 based on the alignment loss 552 and/or the duration loss 554 by updating parameters of the alignment model 400. Thus, the duration model network 230 including the duration predictor 420 and the upsampler 430 may be trained on the alignment loss 552 and/or the duration loss 554.

Referring now specifically to FIG. 3A, in some implementations, an encoder includes a speech encoder 204 and the text encoder 202, described in more detail with reference to FIGS. 313 and 3C. In the example shown, the speech encoder 204 processes audio input (e.g., transcribed speech utterance 304 and un-transcribed speech utterances 306) and the text encoder 206 processes text input (e.g., unspoken text 308). Each of the speech encoder 204 and the text encoder 202 includes a Conformer encoder including a stack of conformer blocks each of which includes a series of multi-headed self attention, depth wise convolution, and feed-forward layers. Alternatively, the audio encoder 210 may include another type of encoder having a stack of self-attention layers/blocks, such as a transformer encoder. Each of the speech encoder 204 and the text encoder 202 may naturally be split into a feature encoder, including a convolution subsampling block 212, and a context network, including a linear layer 214 and a stack of Conformer blocks 216. In some implementations, the convolution subsampling block 212 has two two-dimensional-convolution layers, both with strides (2, 2), resulting in a 4× reduction in the feature sequence length. The convolution subsampling block 212 receives, as input, a sequence of input features/vectors (e.g., mel-frequency spectrograms such as the acoustic frames 110 of FIG. 1) associated with each transcribed speech utterance 304 and each un-transcribed speech utterance 306, and generates, as output, for each of a plurality of output steps, an encoded audio feature 211 that corresponds to a respective one of the transcribed speech utterances 304 or a respective one of the un-transcribed speech utterances 306. The convolution subsampling block 212 may receive, as input, each alignment output 402 and generate, as output, for each of the plurality of output steps, an encoded textual feature 213 that corresponds to a respective one of the alignment outputs 402.

The encoded audio and textual features 211, 213 (i.e., interchangeably referred to as “encoded features 211, 213”) output from the convolution subsampling block 212 may be fed to a masking module 218 where some of the encoded features 211, 213 are randomly chosen and replaced with a trained feature vector shared between all masked time steps to provide corresponding masked encoded audio features 211, 211m and masked encoded textual features 213, 213m. In some examples, the masking module 218 masks the randomly chosen encoded features 211, 213 for masking by randomly sampling without replacement a certain proportion of all time steps to be start indices and then masks the subsequent M consecutive time steps from every sample index, whereby some spans may overlap. After masking is applied, the linear layer 214 and the Conformer blocks 216 of the context network receives the masked encoded features 211m (or encoded features 211, 213 not chosen by the masking module 218) and outputs corresponding contrastive context vectors (i.e., encoded representation) 215 from masked encoded features 211m, 213m. Moreover, a quantizer 217 receives the encoded features 211, 213 as input, and generates quantized vectors (i.e., target context vectors) 219 as output. In some implementations, the quantizer 217 applies random projections to project the corresponding utterance 310 (e.g., encodings 211, 213) using a random projection quantizer. Here, the quantizer 217 generates the target context vectors 219 by mapping the corresponding projected utterance to discrete labels. Thereafter, a contrastive loss module 315 derives a contrastive loss (L_{w2v}) 316 between the contrastive context vectors 215 at the masked positions and the target context vectors 219 as follows.

$${ℒ}_{w 2 v} = - log \frac{exp ( sim ( {c}_{t} , {q}_{t} ) / k )}{{\sum }_{\tilde{q} \sim {Q}_{t}} exp ( sim ( {c}_{t} , \tilde{q} ) / k )} \qquad ( 3 )$$

where cₜ is contrastive context vector 215 centered over a masked time step t and qₜ represents a target context vector 219 at the time step t in a set of K÷1 candidate target context vectors 219 which includes qₜ and K distractors. Distractors may be uniformly sampled from other masked time steps of the same utterance.

The contrastive loss 316 is optimized between the contrastive context vectors 215 at the masked positions and the target context vectors 219. After the encoder converges on the un-transcribed speech utterances 306, the training procedure is repeated on both the alignment outputs 402 corresponding to the unspoken textual utterance 308 and the transcribed speech utterances 304. Thus, the contrastive loss (L_{w2v}) is optimized for both real/human and the unspoken textual utterances 308 represented by alignment outputs 402, with additional auxiliary losses on the transcribed speech utterances 304 and the alignment outputs 402 as described in greater detail below with reference to FIG. 3B. Accordingly, the contrastive part 300a of the training process 300 trains the speech encoder 204 and the text encoder 202 on the derived contrastive loss 316 applied on the corresponding encoded features 211, 213 associated with each alignment output 402, each transcribed speech utterance 304, and each un-transcribed speech utterance 306 provided as input to the encoder 210. Training the encoder may include updating parameters of the encoder 210 based on the contrastive losses 316. The contrastive part 300a of FIG. 3A pretrains the encoder using BEST-RQ.

Referring now to FIG. 3B, the supervised loss part 300b of the training process 300 is configured to inject lexical information into the text encoder 202 of the TTS model 200 during pre-training based on supervised loss terms 342, 344 derived from the transcribed speech utterances 304 and the alignment outputs 402 corresponding to unspoken textual utterances 308 output by the alignment model 400. Notably, the supervised loss part 300b leverages one or more ASR decoders 390 for generating the supervised loss terms (i.e., ASR loss) 342, 344. The ASR decoders 390 may include Connectionist Temporal Classification (CTC) decoders, Listen Attend Spell (LAS) decoders, or RNN-T decoders (e.g., RNN-T architecture). These ASR decoders 390 may include at least one of a phoneme decoder configured to decode a sequence of phonemes or a wordpiece decoder configured to decode a sequence of word pieces. The ASR decoders 390 could also include a grapheme decoder configured to decode a sequence of graphemes.

During the supervised loss part 300b, the text encoder 202 is configured to receive alignment outputs 402 (i.e., text embeddings) from the alignment model 400 and the speech encoder 204 is configured to receive transcribed speech utterances 304. That is, the text encoder 202 generates encoded textual representations 312 for alignment outputs 402 (e.g., corresponding to an unspoken textual utterance 308) and the speech encoder 204 of the encoder 210 generates encoded audio representations 314 for speech inputs (i.e., transcribed speech utterances 304). Here, the encoded textual representations 312 and the encoded audio representations 314 may not both be compatible with the ASR decoders 390. In some examples, the text encoder 202 obtains a corresponding speaker embedding 326 that characterizes speaker characteristics of a corresponding speaker that spoke the training utterance in the respective language and generates the corresponding encoded textual representation 312 based on a concatenation of the corresponding alignment output 402 and the corresponding speaker embedding 326. When the training utterance 310 includes synthetic speech, the speaker embedding 326 may represent the embedding input to the TTS model that generated the training utterance 310 to produce the particular voice characteristics of the training utterance 310. Moreover, the text encoder 202 may obtain a corresponding language embedding 328 that identifies the respective language of the respective training utterance 310 in addition to, or in lieu of, the speaker embedding 326. The training process 300 may concatenate the speaker embedding 326 and the language embedding 328 and provide the concatenation as input to the text encoder 202 such that the text encoder generates the encoded textual representation 312 based on the alignment output 402 and the concatenation of the speaker embedding 326 and the language embedding 328.

Thus, the supervised loss part 300b may employ a shared encoder 250 that receives the encoded textual representations 312 as input, and generates a first encoded shared representation 322 (eₜₑₓₜ) as output. Similarly to the text encoder 202, the TTS model 501 and the ASR model 200 may share the shared encoder 250. Moreover, the shared encoder 250 receives the encoded audio representations 314 as input, and generates a second encoded shared representation (eₛᵤₚ) 324 as output. Accordingly, the shared encoder 250 generates the first and second encoded shared representations 322, 324 into a shared latent representation space compatible with the ASR decoder 390.

In particular, the shared encoder 250 receives, as input, each encoded textual representation 312 that corresponds to the alignment output 402 generated from the unspoken textual utterance 308 and generates, as output, for each of a plurality of time steps, the first encoded shared representation (eₜₑₓₜ) 322 that corresponds to the alignment output 402 at the corresponding output step. The ASR decoder 390 including the phoneme decoder or the wordpiece decoder receives, as input, each first encoded shared representation (i.e., shared encoder output) 332 output from the shared encoder 250 and generates, as output, a first probability distribution 392 over possible speech recognition hypotheses for the corresponding alignment output 402 at the corresponding output step. In some examples, the first probability distribution 392 over possible speech recognition hypotheses includes one of possible phoneme labels, possible word piece labels, or possible grapheme labels. Thus, the first probability distribution 392 over possible speech recognition hypotheses may represent a first speech recognition hypothesis that represents a candidate transcription for the corresponding training utterance 310. As such, the first probability distribution 392 may also be referred to as the first speech recognition hypothesis 392 herein. Thereafter, an supervised loss module 340 may determine an alignment output loss term 342 based on the first probability distribution 392 over possible speech recognition hypotheses for the alignment output 402 corresponding to the unspoken textual utterance 308. Here, the corresponding unspoken textual utterance 308 in which the alignment output 402 is generated from also serves as a ground-truth transcription 302. Since the alignment output 402 may be masked, the alignment output loss term 342 also serves as an aligned MLM loss. The supervised loss part 300b may train the text encoder 202 and/or speech encoder 204 on the alignment output loss term 342 by updating parameters of the text encoder 202 and/or the speech encoder 204 based on the alignment output loss term 342.

Similarly, during the supervised loss part 300b, the shared encoder 250 receives, as input, each transcribed encoded audio representation 314 that corresponds to the transcribed speech utterance 304 and generates, as output, for each of a plurality of time steps, a second encoded shared representation (eₛᵤₚ) 334 that corresponds to the transcribed speech utterance 304 at the corresponding time step. The ASR decoder 390 including the phoneme decoder or the wordpiece decoder receives, as input, each second encoded shared representation (i.e., shared encoder output) 334 output from the shared encoder 250 and generates, as output, a second probability distribution 394 over possible speech recognition hypotheses for the corresponding transcribed speech utterance 304 at the corresponding time step. In some examples, the second probability distribution 394 over possible speech recognition hypotheses includes the one of possible phoneme labels, the possible word piece labels, or the possible grapheme labels. Thus, the second probability distribution 394 over possible speech recognition hypotheses may represent a second speech recognition hypothesis that represents a candidate transcription for the corresponding training utterance 310. As such, the second probability distribution 394 may also be referred to as the second speech recognition hypothesis 394 herein. Thereafter, the supervised loss module 340 may determine a speech loss term 344 based on the second probability distribution 394 over possible speech recognition hypotheses and the corresponding transcription 302 paired with the transcribed speech utterance 304. Here, the corresponding transcription 302 serves as a ground-truth transcription and may include a sequence of target phonemes, target word pieces, and/or target graphemes. The supervised loss part 300b may train the text encoder 202 and/or speech encode 204 on the speech loss term 344 by updating parameters of the text encore 202 and/or speech encoder 204 based on the speech loss term 344.

The un-transcribed speech utterances 306 and the unspoken textual utterances 308 each correspond to “unpaired” training data whereby the contrastive loss (L_{w2v}) 316 derived from the unspoken textual utterances (Xₜₑₓₜ) 308 may be combined with the supervised loss [symbol] associated with the alignment output loss term 342 to obtain an unspoken textual loss function, [symbol] , as follows.

$${𝒥}_{text} = {ℒ}_{w 2 v} ( x \vert {θ}_{e} ) + {ℒ}_{aux} ( y \vert x , {θ}_{e} , {θ}_{d} ) \qquad ( 4 )$$

Likewise, the contrastive loss (L_{w2v}) 316 derived from the un-transcribed speech utterances (Xᵤₙₛᵤₚ) 306 may be used to express an unsupervised speech loss function, [symbol] , as follows.

$${𝒥}_{unsup\_speech} = {𝒥}_{w 2 v} ( {x}^{*} \vert {θ}_{e} ) \qquad ( 5 )$$

During training of the text encoder 202 and the speech encoder 204, the alignment outputs 402 and the un-transcribed utterances 306 may be separated or mixed within each batch. In order to force the text encoder 202 to learn representations that are effective for both alignment outputs 402 corresponding to unspoken textual utterances 308 and (human/real) speech, the loss mask a is applied when combining the loss functions [symbol] and of Equations. 5 and 6 to obtain an unpaired data loss function, [symbol] , as follows.

$${𝒥}_{unpaired} = σ {𝒥}_{t e x t} + ( 1 - σ ) {𝒥}_{s p e e c h} \qquad ( 6 )$$

The transcribed speech utterances 304 corresponds to “paired” and “supervised” training data whereby the derived contrastive loss L_{w2v} and the derived supervised loss [symbol] associated with the speech loss term 344 may be combined to obtain a paired data loss function, [symbol] , as follows.

$${𝒥}_{paired} = {ℒ}_{w 2 v} ( x \vert {θ}_{e} ) + {ℒ}_{aux} ( y \vert x , {θ}_{e} , {θ}_{d} ) \qquad ( 7 )$$

Referring to FIG. 3C, the consistency regularization part (i.e., modality matching part) 300c of the training process 300 is configured to promote the text encoder 202 and the speech encoder 204 to learn consistent predictions between speech (e.g., real/human speech) and alignment outputs 402 corresponding to unspoken textual utterances 308 by generating a consistent loss term ( [symbol] (θ)) 352 between training utterance pairs 303 that each include a corresponding one of the transcribed speech utterances (Xₛᵤₚ) 304 and a paired alignment output 104 of the same utterance as the corresponding transcribed speech utterance 304. As such, the speech utterance 304 and the paired alignment output 404 of each training utterance pair 303 is associated with a same ground-truth transcription. In short, the consistent loss term 352 between the transcribed speech utterance 304 and paired alignment output 404 of the same training utterance provides an unsupervised training aspect by encouraging the encoder 210 to behave consistently regardless of whether the training utterance belongs to speech (i.e., speech training data) or the alignment output (i.e., text training data) and independent of supervised loss terms between the ground-truth transcription 302 and each of speech recognition hypotheses output by the auxiliary decoder 390; and speech recognition hypothesis output by the auxiliary decoder 390.

Similar to the alignment outputs 402 generated from the unspoken textual utterances 308 in FIG. 3B, the alignment model 400 may generate each paired alignment output 404 using the corresponding transcription 302 that is paired with the transcribed speech utterance 304. Here, the speech representation 304 is associated with paired alignment output 404 generated by the alignment model 400 mapping the unspoken textual utterance 308 into speech frames.

During the consistency regularization part 300c, the text encoder 202 receives, as input, each paired alignment output 404 and generates, as output, for each of a plurality of time steps, an encoded textual representation 313 that corresponds to the paired alignment output 404 at the corresponding output step. In some examples, the text encoder 202 obtains a corresponding speaker embedding 326 that characterizes speaker characteristics of a corresponding speaker that spoke the training utterance in the respective language and generates the corresponding encoded textual representation 312 based on a concatenation of the corresponding alignment output 402 and the corresponding speaker embedding 326. Moreover, the text encoder 202 may obtain a corresponding language embedding 328 that identifies the respective language of the respective training utterance 310 in addition to, or in lieu of, the speaker embedding 326. The training process 300 may concatenate the speaker embedding 326 and the language embedding 328 and provide the concatenation as input to the text encoder 202 such that the text encoder generates the encoded textual representation 312 based on the alignment output 402 and the concatenation of the speaker embedding 326 and the language embedding 328.

The shared encoder 250 receives, as input, the encoded textual representation 313 and generates, as output, a first encoded shared representation (e*ₛᵤₚ) 323. The auxiliary decoder 390 including the phoneme decoder or the wordpiece decoder receives, as input, each first encoded shared representation 323 output from the shared encoder 250 and generates, as output, a first probability distribution 311 over possible speech recognition hypotheses for the corresponding paired alignment output 404 at the corresponding output step. In some examples, the first probability distribution 311 over possible speech recognition hypotheses includes one of possible phoneme labels or possible word piece labels.

Similarly, the speech encoder 204 receives, as input, each transcribed speech utterance 304 as a sequence of features/vectors (e.g., mel-frequency spectrograms such as the acoustic frames 110 of FIG. 1) and generates, as output, for each of a plurality of time steps, an encoded audio representation 314 that corresponds to the transcribed speech utterance 304 at the corresponding output step. The shared encoder 250 receives, as input, the encoded audio representation 314 and generates, as output, a second encoded shared representation (eₛᵤₚ) 324. The auxiliary decoder 390 including the phoneme decoder or the wordpiece decoder receives, as input, each second encoded shared representation 324 output from the shared encoder 250 and generates, as output, a second probability distribution 394 over possible speech recognition hypotheses for the corresponding transcribed speech utterance 304 at the corresponding time step. In some examples, the second probability distribution 394 over possible speech recognition hypotheses includes the one of the possible phoneme labels or the possible word piece labels.

With continued reference to FIG. 3C, the consistency regularization part 300c of the training process 300 further determines, at each of the plurality of output steps for each training utterance pair 301, the consistent loss term ( [symbol] (θ)) 352 for the corresponding training utterance pair 301 based on the first probability distribution 311 over possible speech recognition hypotheses and the second probability distribution 394 over possible speech recognition hypotheses. For instance, the training process 300 may employ a consistency loss term module 350 configured to receive, at each time step, the corresponding speech and speech recognition results 311, 394 output by the auxiliary decoder 390, and determine the consistency loss term 352 for the corresponding training utterance pair 301 at the time step.

In some examples, the consistency regularization part 300c of the training process 300 determines the consistent loss term 352 based on a Kullback-Leibler divergence (D_{KL}) between the first probability distribution 311 over possible speech recognition hypotheses and the second probability distribution 394 over possible speech recognition hypotheses. The consistent loss term 352 based on D_{KL} may be expressed by the following equation.

$${𝒥}_{c o n s} ( θ ) = {𝒟}_{KL} ( {p}_{\tilde{θ}} ( y \vert x ) ‖ {p}_{θ} ( y \vert \hat{x} ) ) \qquad ( 8 )$$

Here, the consistent loss term 352 determined for the training utterance pair 301 at each time step provides an “unsupervised” loss term that is independent of the accuracy of the auxiliary decoder 390 (e.g., independent of the supervised loss terms 342, 344 of FIG. 3B), and thus, may be employed to update parameters of the encoder 210 for promoting consistency between speech representations and alignment outputs of the same utterances. In batch training, the consistent loss term 352 may correspond to an average loss term obtained for the batch. In other words, the consistent loss term 352 permits the text encoder 202 and the speech encoder 204 to learn to behave the same, e.g., make consistent encoded representation predictions on both speech (e.g., real/human speech) and alignment outputs of a same training utterance, regardless of whether the training utterance belongs to speech or alignment outputs.

In some implementations, the consistency loss module 350 receives the encoded textual representations 313 generated by the text encoder 202 for the corresponding transcription 302 and the encoded audio representation (i.e., speech encodings) 314 generated by the speech encoder 204 for the corresponding reference speech representation (i.e., transcribed speech utterance) 304. Here, the training utterance pairs 303 correspond to the same training utterance 310, the consistency loss module 350 may determine a feature loss 354 between the encoded textual representation 313 and the speech encodings 314 corresponding to the same training utterance 310. Thus, the consistency loss module 350 determines feature loss 354 before decoding the encoded representations 313, 314 into speech recognition hypotheses. The training process 300 may train the TTS model 501 based on the feature loss 354 determined for each training utterance 310.

Lastly, the training process 300 may combine the unpaired data loss function ( [symbol] ), the paired data loss function ( [symbol] ), and the consistent loss term ( [symbol] ) to obtain an overall loss term, [symbol] , that may be expressed as follows.

$${𝒥}_{tts 4 pretrain 2} = {𝒥}_{unpaired} + {λ}_{1} 𝒥 paired + {λ}_{2} {𝒥}_{cons} \qquad ( 9 )$$

where λ₁ may be equal to 1.0 and λ₂ is equal to 0.1. The training process 300 may pre-train the audio encoder speech encoder 204 and the text encoder 202 using the overall loss term, [symbol] , by updating parameters of the speech encoder 204 and the text encoder 202 to effectively teach the speech encoder 204 and the text encoder 202 to learn shared representations between speech and text. After pre-training the speech encoder 204 and the text encoder 202, the training process 300 may fine-tune the pre-trained speech encoder 204 and the text encoder 202 on transcribed speech utterances that may include supervised training samples of both alignment outputs corresponding to unspoken textual utterance 308 and (e.g., human speech).

In some implementations, the training process 300 for pre-training the speech encoder 204 and the text encoder 202 applies encoder consistency regularization. Unlike decoder consistency regularization applied to auxiliary decoder(s) during the consistency regularization part 300c that requires hypothesized labels (e.g., transcripts 302 and unspoken textual utterances 308), encoder consistency regularization does not require hypothesized labels and therefore has the advantage being allowed to be applied to all the training data 304, 306, 308. Encoder consistency regularization may be applied via Hierarchical Contrastive consistency Regularization (HCCR) techniques where encoder activations e, e* from original/non-augmented and augmented speech are projected through an auxiliary network to generate z and z*. Thereafter, positive and negative pairs are constructive and a contrastive loss l_{t,z,z*} is calculated as follows.

$${l}_{t , z , {z}^{*}} = - log \frac{exp ( sim ( {z}_{t}^{*} , {z}_{t} ) / τ )}{{\sum }_{k = 1}^{T} exp ( sim ( {z}_{t}^{*} , {z}_{k} ) / τ )} \qquad ( 10 )$$

Specific to HCCR, a Convolutional Neural Network (CNN) projection network may calculate projections over increasing length segments of encoder activations e (30, 50, 120 ms) to yield 3 views (V) and draw negative examples from the same utterance for short segments, and from other utterances in the batches with 120 ms segments. Accordingly, an HCCR loss may be calculated over the transcribed speech utterances 304 (paired speech), the un-transcribed speech utterances 306 (unpaired speech), and the alignment outputs 402 generated from the unspoken textual utterances 308 as follows.

$${ℒ}_{e n {c}_{-} c o n s} = {\sum }_{v = 1}^{V} {\sum }_{t = 1}^{{T}^{( ν )}} {l}_{t , {z}^{* ( v )} , {z}^{( v )}} \qquad ( 11 )$$

The HCCR loss calculated by Equation 11 may be added to Equation 9 with a coefficient of 1e-3 as part of the overall loss term, [symbol] , for use in pre-training the speech encoder 204 and the text encoder 202.

In short, the training process 300 trains the TTS model 201 using the sets of training utterances 310 by training the speech decoder 204, the text encoder 202, and/or the shared encoder 250 based on any of the losses derived by the training process 300. Even though the speech decoder 204 and the shared encoder 250 may not be employed by the TTS model 201 during inference, the training process 300 trains these components to learn better shared representations between speech and text thereby further training the TTS model 501 (e.g., text encoder 202 of the TTS model 501) to generate encodings that accurately represent human speech.

Referring now to FIG. 3D, in some implementations, the training process 300 includes a training data generation process 300, 300d. Here, the speech encoder 204 receives the un-transcribed speech utterances 306 and generates a corresponding unpaired speech encoding 314 for each respective un-transcribed speech utterance (i.e., unpaired speech utterance) 306. The shared encoder 250 receives the unpaired speech encodings 314 and generates a corresponding unpaired shared encoder output 324 for each respective unpaired speech encoding 314. The auxiliary decoder 390 generates a pseudo label 394 representing a candidate transcription for the corresponding unpaired spoken utterance 306. That is, the probability distribution 394 over possible speech recognition hypotheses may represent a single transcription such that the candidate transcription serves as a self-supervised label for the unpaired speech utterance 306. As such, the training process 300 may pair the pseudo label 394 with the corresponding unpaired speech utterance 306 such that the pairing now represents a transcribed speech utterance 304 which is added to the training data 301.

Referring now to FIG. 3E, in some implementations, the training process 300 includes a language loss part 300, 300e. During the language loss part 300e, the text encoder 202 is configured to receive alignment outputs 402 (i.e., text embeddings) from the alignment model 400 and the speech encoder 204 is configured to receive transcribed speech utterances 304. That is, the text encoder 202 generates encoded textual representations 312 for alignment outputs 402 (e.g., corresponding to an unspoken textual utterance 308) and the speech encoder 204 of the encoder 210 generates encoded audio representations 314 for speech inputs (i.e., transcribed speech utterances 304). In some examples, the text encoder 202 obtains a corresponding speaker embedding 326 that characterizes speaker characteristics of a corresponding speaker that spoke the training utterance in the respective language and generates the corresponding encoded textual representation 312 based on a concatenation of the corresponding alignment output 402 and the corresponding speaker embedding 326. When the training utterance 310 includes synthetic speech, the speaker embedding 326 may represent the embedding input to the TTS model that generated the training utterance 310 to produce the particular voice characteristics of the training utterance 310. Moreover, the text encoder 202 may obtain a corresponding language embedding 328 that identifies the respective language of the respective training utterance 310 in addition to, or in lieu of, the speaker embedding 326. The training process 300 may concatenate the speaker embedding 326 and the language embedding 328 and provide the concatenation as input to the text encoder 202 such that the text encoder generates the encoded textual representation 312 based on the alignment output 402 and the concatenation of the speaker embedding 326 and the language embedding 328.

The language loss part 300e may include a language identifier 360. The language identifier 360 may be integrated into any component of the TTS model 200. For example, the language identifier 360 may be integrated into the encoder or the decoder of the TTS model 200. The language identifier 360 is configured to generate or predict a predicted language identifier 362 of the corresponding training utterance 310. That is, the language identifies may generate a predicted language identifier 362 based on the encoded textual representation 312 or generate a predicted language identifier 362 based on the encoded audio representation 314. Thereafter, a language loss module 370 may receive the predicted language identifier 362 predicted for each training utterance 310 and determined a text language identifier loss 372 or a speech language identifier loss 374. That is, predicted language identifiers 362 generated from encoded textual representations 312 may be compared with the corresponding language embeddings 328 paired with the training utterance 310 such that the language loss module 370 determines the text language identifier loss 372. Similarly, predicted language identifiers 362 generated from encoded audio representations 314 may be compared with the corresponding language embeddings 328 paired with the training utterance 310 such that the language loss module 370 determines the speech language identifier loss 374. The training process 300 may update parameters of the language identifier 360 and/or any other component of the TTS model 200 based on the language identifier losses 372, 374. Moreover, the training process 300 may determine a TTS loss (i.e., overall loss) 305 based on any combination of the losses determined during the training process 300. The example shown shows the language loss module 370 determining the TTS loss 305 by way of example only as any loss module may determine the TTS loss 305 and/or the training process 300 may combine each loss from the loss modules to determine the TTS loss 305. Thus, the TTS loss 305 may include any combination of losses determined during the training process 300 or the training process 500 (FIG. 5) such that the training process 300 may train the TTS model 200 by updating parameters of the TTS model 200 based on the TTS loss 305.

Referring back to FIG. 2, after the training process 300 of FIGS. 3A-3E trains the multilingual TTS model 200, an joint training process jointly trains the multilingual TTS model 200 and the zero-shot VT module 240 to integrate the zero-shot VT module 240 into the multilingual TTS model 200 for performing zero-shot voice transfer across languages. Here, a multilingual training data set is used to jointly train the multilingual TTS model 200 and the zero-shot VT module 240. The multilingual training data set includes around 200,000 hours of transcribed longform speech samples spanning several locals as well as TITS data composed of commercially licensed studio recordings featuring around 775 voice talents across several locals. The multilingual training data set may cover over 100 different locales. The joint training process may provide the transcription of each speech sample to the text encoder and use the audio of the speech sample as the target speech the multilingual TTS model 200 is learning to predict. Here, a random consecutive chunk (e.g., spanning 1-1-5 seconds) is extracted from the speech sample corresponding to the target speech and passed to the VT module 240 as reference speech 210 to generate a final embedding vector (h) summarizing the voice and prosodic characteristics from the reference speech. This helps prevent leakage of duration and linguistic information. IN some examples, the length of the chunk is sampled using a clipped Gaussian distribution with a mean of eight (8) seconds and a standard deviation of three (3) seconds.

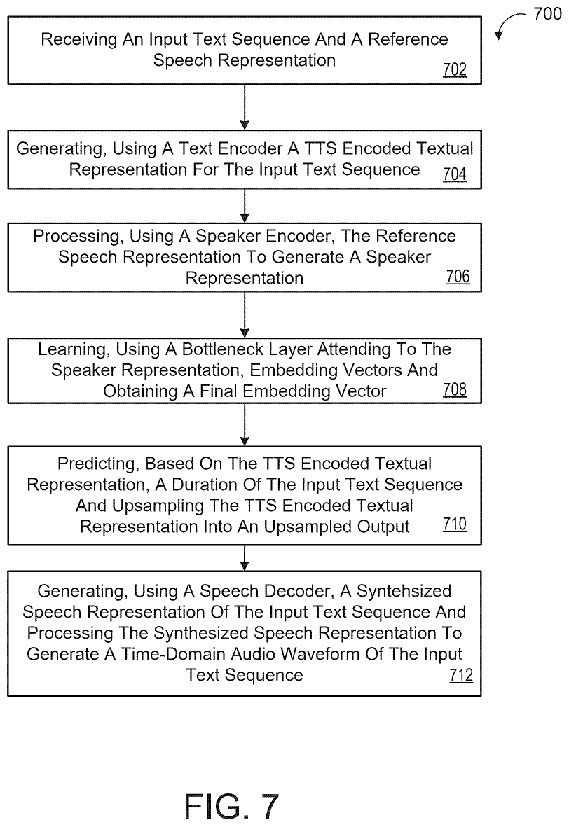

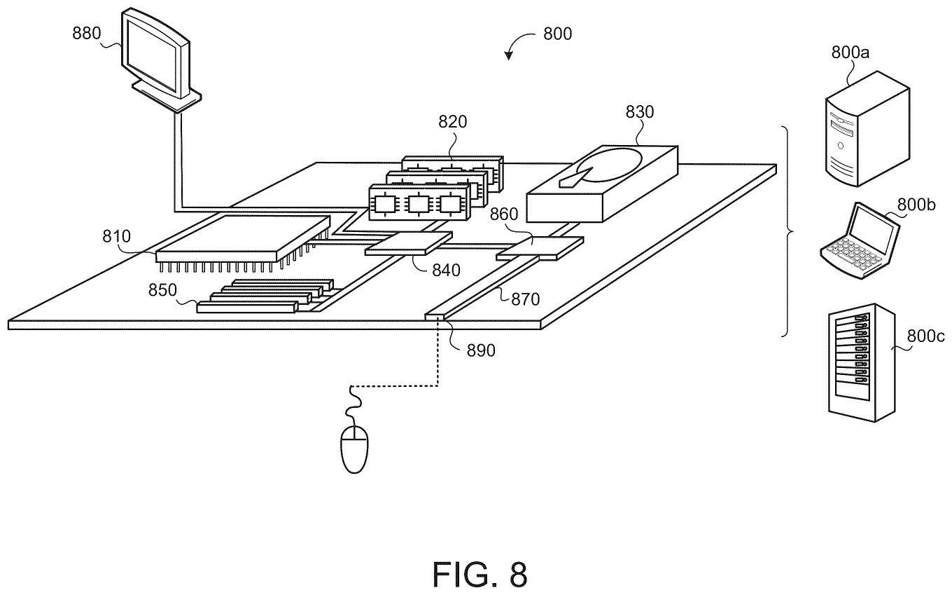

FIG. 7 is a flowchart of an exemplary arrangement of operations for a computer-implemented method 700 for performing zero-shot voice conversion across languages using a massively multilingual TTS model 200 integrating a Voice Transfer (VT) module 240. The method 700 may execute on data processing hardware 810 (FIG. 8) based on instructions stored on memory hardware 820 (FIG. 8) in communication with the data processing hardware 810. At operation 702, the method includes receiving an input text sequence 220 and a reference speech representation 210. The input text sequence 220 characterizes an utterance to be converted into synthesized speech 280 and the reference speech representation 210 characterizes a reference utterance spoken by a target speaker. At operation 704, the method 700 includes generating, using a text encoder 202, a text-to-speech (TTS) encoded textual representation 229 for the input text sequence 210. At operation 706, the method 700 includes processing, using the a speaker encoder of the VT module 240, the reference speech representation 210 to generate a speaker representation 244. Here, the speaker representation characterizes voice characteristics of the target speaker. At operation 708, the method 700 includes learning, using a bottleneck layer 600 having an attention mechanism 610 configured to attend to the speaker representation 244, fine-grained embedding vectors 620 and obtaining a final embedding vector (h) based on the fine-grained embedding vectors 620.

At operation 710, using a duration model network 230, the method 700 also includes predicting, based on the TTS encoded textual representation, a duration of the input text sequence, and upsampling, based on the duration of the input text sequence, the TTS encoded textual representation into an upsampled output specifying a number of frames. At operation 712, the method 700 also includes generating, using a speech decoder 260 configured to receive the upsampled output 258 and the final embedding vector, a synthesized speech representation 270 of the input text sequence and processing, using a speech synthesizer 275, the synthesized speech representation 270 to generate a time-domain audio waveform of the input text sequence 220 that clones a voice of the target.

FIG. 8 is schematic view of an example computing device 800 that may be used to implement the systems and methods described in this document. The computing device 800 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 800 includes a processor 810, memory 820, a storage device 830, a high-speed interface/controller 840 connecting to the memory 820 and high-speed expansion ports 850, and a low speed interface/controller 860 connecting to a low speed bus 870 and a storage device 830. Each of the components 810, 820, 830, 840, 850, and 860, are interconnected using various busses, and may be mounted on a common motherboard or in other manners as appropriate. The processor 810 can process instructions for execution within the computing device 800, including instructions stored in the memory 820 or on the storage device 830 to display graphical information for a graphical user interface (GUI) on an external input/output device, such as display 880 coupled to high speed interface 840. In other implementations, multiple processors and/or multiple buses may be used, as appropriate, along with multiple memories and types of memory. Also, multiple computing devices 800 may be connected, with each device providing portions of the necessary operations (e.g., as a server bank, a group of blade servers, or a multi-processor system).

The memory 820 stores information non-transitorily within the computing device 800. The memory 820 may be a computer-readable medium, a volatile memory unit(s), or non-volatile memory unit(s). The non-transitory memory 820 may be physical devices used to store programs (e.g., sequences of instructions) or data (e.g., program state information) on a temporary or permanent basis for use by the computing device 800. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 830 is capable of providing mass storage for the computing device 800. In some implementations, the storage device 830 is a computer-readable medium. In various different implementations, the storage device 830 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 820, the storage device 830, or memory on processor 810.

The high speed controller 840 manages bandwidth-intensive operations for the computing device 800, while the low speed controller 860 manages lower bandwidth-intensive operations. Such allocation of duties is exemplary only. In some implementations, the high-speed controller 840 is coupled to the memory 820, the display 880 (e.g., through a graphics processor or accelerator), and to the high-speed expansion ports 850, which may accept various expansion cards (not shown). In some implementations, the low-speed controller 860 is coupled to the storage device 830 and a low-speed expansion port 890. The low-speed expansion port 890, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 800 may be implemented in a number of different forms, as shown in the figure. For example, it may be implemented as a standard server 800a or multiple times in a group of such servers 800a, as a laptop computer 800b, or as part of a rack server system 800c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EEPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method when executed on data processing hardware causes the data processing hardware to perform operations comprising:
receiving an input text sequence characterizing an utterance to be converted into synthesized speech;
receiving a reference speech representation characterizing a reference utterance spoken by a target speaker:
generating, using a text encoder, a text-to-speech (ITS) encoded textual representation for the input text sequence;
processing, using a speaker encoder of a voice transfer (VT) module, the reference speech representation to generate a speaker representation, the speaker representation characterizing voice characteristics of the target speaker;
learning, using a bottleneck layer having an attention mechanism configured to attend to the speaker representation, fine-grained embedding vectors;
obtaining a final embedding vector based on the fine-grained embedding vectors;
using a duration model network:
predicting, based on the TTS encoded textual representation, a duration of the input text sequence; and
upsampling, based on the duration of the input text sequence, the TTS encoded textual representation into an upsanmpled output specifying a number of frames;
generating, using a speech decoder configured to receive the upsampled output and the final embedding vector, a synthesized speech representation of the input text sequence; and
processing, using a speech synthesizer, the synthesized speech representation to generate a time-domain audio waveform of the input text sequence that clones a voice of the target speaker.

2. The computer-implemented method of claim 1, wherein:
the speaker representation comprises a sequence of speaker vectors; and
obtaining the final embedding vector comprises performing average pooling on the sequence fine-grained embedding vectors to generate an average-pooled speaker embedding vector, the average-pooled speaker embedding vector comprising the final embedding vector.

3. The computer-implemented method of claim 1, wherein:
the speaker representation comprises a pooled summary speaker vector obtained by performing pooling and L2 normalization on a sequence of speaker embedding vectors output by the speaker encoder; and
obtaining the final embedding vector comprises computing a weighted average of the fine-grained embedding vectors, the weighted average of the fine-grained embedding vectors comprising the final embedding vector.

4. The computer-implemented method of claim 3, wherein the bottleneck layer comprises multiple bottleneck layers replicated to each of the duration model network and each layer of the spectrogram decoder, each bottleneck layer of the multiple bottleneck layers configured to receive the pooled summary speaker vector.

5. The method of claim 1, wherein:
the duration model network comprises one or more multi-head attention layers; and
an output of each multi-head attention layer of the duration model network is concatenated with the final embedding vector via a residual adapter.

6. The method of claim 1, wherein:
the speech decoder comprises one or more multi-head attention layers; and
an output of at least one multi-head attention layer of the speech decoder is concatenated with the final embedding vector via a residual adapter.

7. The method of claim 1, wherein the utterance characterized by the input text sequence is different than the reference utterance.

8. The method of claim 1, wherein the reference utterance spoken by the target speaker is in a different language than the utterance characterized by the input text sequence.

9. The method of claim 1, wherein the speaker encoder comprises a convolutional layer followed by a stack of multi-head attention layers.

10. The method of claim 9, wherein the stack of multi-head attention layers comprises a stack of transformer layers or a stack of conformer layers.

11. A system comprising:
data processing hardware; and
memory hardware in communication with the data processing hardware, the memory hardware storing instructions that when executed by the data processing hardware cause the data processing hardware to perform operations comprising:
receiving an input text sequence characterizing an utterance to be converted into synthesized speech;
receiving a reference speech representation characterizing a reference utterance spoken by a target speaker;
generating, using a text encoder, a text-to-speech (TTS) encoded textual representation for the input text sequence;
processing, using a speaker encoder of a voice transfer (VT) module, the reference speech representation to generate a speaker representation, the speaker representation characterizing voice characteristics of the target speaker;
learning, using a bottleneck layer having an attention mechanism configured to attend to the speaker representation, fine-grained embedding vectors;
obtaining a final embedding vector based on the fine-grained embedding vectors;
using a duration model network:
predicting, based on the TTS encoded textual representation, a duration of the input text sequence; and
upsampling, based on the duration of the input text sequence, the TTS encoded textual representation into an upsampled output specifying a number of frames;
generating, using a speech decoder configured to receive the upsampled output and the final embedding vector, a synthesized speech representation of the input text sequence; and
processing, using a speech synthesizer, the synthesized speech representation to generate a time-domain audio waveform of the input text sequence that clones a voice of the target speaker.

12. The system of claim 11, wherein:
the speaker representation comprises a sequence of speaker vectors; and
obtaining the final embedding vector comprises performing average pooling on the sequence fine-grained embedding vectors to generate an average-pooled speaker embedding vector, the average-pooled speaker embedding vector comprising the final embedding vector.

13. The system of claim 11, wherein:
the speaker representation comprises a pooled summary speaker vector obtained by performing pooling and L2 normalization on a sequence of speaker embedding vectors output by the speaker encoder; and
obtaining the final embedding vector comprises computing a weighted average of the fine-grained embedding vectors, the weighted average of the fine-grained embedding vectors comprising the final embedding vector.

14. The system of claim 13, wherein the bottleneck layer comprises multiple bottleneck layers replicated to each of the duration model network and each layer of the spectrogram decoder, each bottleneck layer of the multiple bottleneck layers configured to receive the pooled summary speaker vector.

15. The system of claim 11, wherein:
the duration model network comprises one or more multi-head attention layers; and
an output of each multi-head attention layer of the duration model network is concatenated with the final embedding vector via a residual adapter.

16. The system of claim 11, wherein:
the speech decoder comprises one or more multi-head attention layers, and
an output of at least one multi-head attention layer of the speech decoder is concatenated with the final embedding vector via a residual adapter.

17. The system of claim 11, wherein the utterance characterized by the input text sequence is different than the reference utterance.

18. The system of claim 11, wherein the reference utterance spoken by the target speaker is in a different language than the utterance characterized by the input text sequence.

19. The system of claim 11, wherein the speaker encoder comprises a convolutional layer followed by a stack of multi-head attention layers.

20. The system of claim 19, wherein the stack of multi-head attention layers comprises a stack of transformer layers or a stack of conformer layers.
